(19) United States
(12) Patent Application Publication
(10) Pub. No.: US 2022/0302993 A1
(43) Pub. Date: Sep. 22, 2022

(54) CELLULAR SIGNAL EXTENSION FOR PRIVATE NETWORK DEVICE MANAGEMENT

(71) Applicant: AT&T Intellectual Property I, L.P., Atlanta, GA (US)

(72) Inventor: Vazrik Hovsepian, Carrollton, TX (US)

(21) Appl. No.: 17/202,573

(22) Filed: Mar. 16, 2021

(51) Int. Cl. H04B 7/155; H04W 88/16; H04W 8/24; H04B 7/10

(52) U.S. Cl. CPC H04B 7/1555; H04W 88/16; H04W 8/24; H04B 7/10

(57) ABSTRACT

The described technology is generally directed towards antenna devices that extend cellular signals, thereby allowing for improved private network device management. Example devices can include an antenna element adapted for remote cellular communication and an antenna element adapted for local cellular communication, along with appropriate processing functions to relay communications between the antenna elements. Furthermore, example devices can include a residential gateway interface or a Wi-Fi antenna, along with appropriate processing functions to relay communications between the residential gateway interface or Wi-Fi antenna and the antenna element adapted for remote cellular communication.

### TECHNICAL FIELD

The subject application is related to fourth generation (4G), fifth generation (5G), and subsequent generation cellular communication systems, e.g., to extending cellular communication system signals to increase the availability of the cellular communication system signals and to simultaneously support private networks.

### BACKGROUND

Current customer antenna products, such as fixed wireless outdoor wireless antennas (OWAs) or indoor antennas (IAs) in a building or home, receive a cellular signal, e.g., a 4G or a 5G signal, and broadcast Wi-Fi signals via connectivity to Wi-Fi residential gateways or via integrated Wi-Fi modules. While such antenna equipment configurations are suitable for many customers, they are inadequate for others.

For example, sophisticated customers, such as factories, large farms, and others may have their own private networks with sophisticated data collection and management features. The rise of the so-called Internet of Things (IoT) has led to increasing numbers of devices that can report useful data and can be centrally managed, with a diverse range of corresponding business efficiencies and advantages. However, devices that connect to 4G or 5G networks via Wi-Fi may not be as straightforward to manage as compared to devices that connect directly using a cellular signal.

The above-described background is merely intended to provide a contextual overview of some current issues, and is not intended to be exhaustive. Other contextual information may become further apparent upon review of the following detailed description.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates an example wireless communication system, in accordance with various aspects and embodiments of the subject disclosure.

FIG. 2 illustrates an example outdoor antenna device, in accordance with various aspects and embodiments of the subject disclosure.

FIG. 3 illustrates an example indoor antenna device, in accordance with various aspects and embodiments of the subject disclosure.

FIG. 4 illustrates an example processor for an outdoor antenna device, in accordance with various aspects and embodiments of the subject disclosure.

FIG. 5 illustrates an example processor for an indoor antenna device, in accordance with various aspects and embodiments of the subject disclosure.

FIG. 6 illustrates an example private network, in accordance with various aspects and embodiments of the subject disclosure.

FIG. 7 is a flow diagram representing example operations of an outdoor antenna device, in accordance with various aspects and embodiments of the subject disclosure.

FIG. 8 is a flow diagram representing example operations of an indoor antenna device, in accordance with various aspects and embodiments of the subject disclosure.

FIG. 9 is a flow diagram representing example operations of a private network, in accordance with various aspects and embodiments of the subject disclosure.

FIG. 10 is a block diagram of an example computer that can be operable to execute processes and methods in accordance with various aspects and embodiments of the subject disclosure.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details, and without applying to any particular networked environment or standard.

One or more aspects of the technology described herein are generally directed towards antenna devices that extend cellular signals, thereby allowing for improved private network device management. Example devices can include an antenna element adapted for remote cellular communication and an antenna element adapted for local cellular communication, along with appropriate processing functions to relay communications between the antenna elements. Furthermore, example devices can include a residential gateway interface or a Wi-Fi antenna, along with appropriate processing functions to relay communications between the residential gateway interface or Wi-Fi antenna and the antenna element adapted for remote cellular communication. Further aspects and embodiments are described in detail below.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” BS transceiver, BS device, cell site, cell site device, “gNode B (gNB),” “evolved Node B (eNode B),” “home Node B (HNB)” and the like, refer to wireless network components or appliances that transmit and/or receive data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “customer entity,” “consumer,” “customer entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

It should be noted that although various aspects and embodiments have been described herein in the context of 4G, 5G, or other next generation networks, the disclosed aspects are not limited to a 4G or 5G implementation, and/or other network next generation implementations, as the techniques can also be applied, for example, in third generation (3G), or other 4G systems. In this regard, aspects or features of the disclosed embodiments can be exploited in substantially any wireless communication technology. Such wireless communication technologies can include universal mobile telecommunications system (UMTS), global system for mobile communication (GSM), code division multiple access (CDMA), wideband CDMA (WCMDA), CDMA2000, time division multiple access (TDMA), frequency division multiple access (FDMA), multi-carrier CDMA (MC-CDMA), single-carrier CDMA (SC-CDMA), single-carrier FDMA (SC-FDMA), orthogonal frequency division multiplexing (OFDM), discrete Fourier transform spread OFDM (DFT-spread OFDM), single carrier FDMA (SC-FDMA), filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM (CP-OFDM), resource-block-filtered OFDM, wireless fidelity (Wi-Fi), worldwide interoperability for microwave access (WiMAX), wireless local area network (WLAN), general packet radio service (GPRS), enhanced GPRS, third generation partnership project (3GPP), long term evolution (LTE), LTE frequency division duplex (FDD), time division duplex (TDD), 5G, third generation partnership project 2 (3GPP2), ultra mobile broadband (UMB), high speed packet access (HSPA), evolved high speed packet access (HSPA+), high-speed downlink packet access (HSDPA), high-speed uplink packet access (HSUPA), Zigbee, or another institute of electrical and electronics engineers (IEEE) 802.12 technology. In this regard, all or substantially all aspects disclosed herein can be exploited in legacy telecommunication technologies.

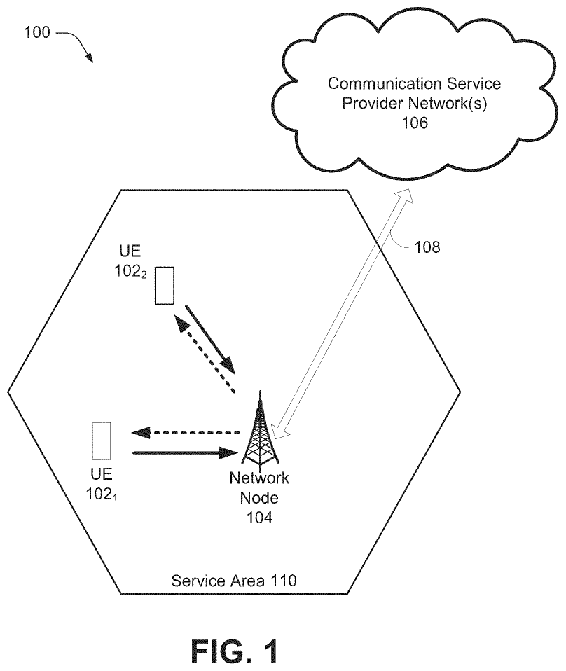

FIG. 1 illustrates a non-limiting example of a wireless communication system 100 which can be used in connection with at least some embodiments of the subject disclosure. In one or more embodiments, system 100 can comprise one or more user equipment UEs 102₁, 102₂, referred to collectively as UEs 102, a network node 104 that supports cellular communications in a service area 110, also known as a cell, and communication service provider network(s) 106.

The non-limiting term “user equipment” can refer to any type of device that can communicate with a network node 104 in a cellular or mobile communication system 100. UEs 102 can have one or more antenna panels having vertical and horizontal elements. Examples of UEs 102 comprise target devices, device to device (D2D) UEs, machine type UEs or UEs capable of machine to machine (M2M) communications, personal digital assistants (PDAs), tablets, mobile terminals, smart phones, laptop mounted equipment (LME), universal serial bus (USB) dongles enabled for mobile communications, computers having mobile capabilities, mobile devices such as cellular phones, laptops having laptop embedded equipment (LEE, such as a mobile broadband adapter), tablet computers having mobile broadband adapters, wearable devices, virtual reality (VR) devices, heads-up display (HUD) devices, smart cars, machine-type communication (MTC) devices, augmented reality head mounted displays, and the like. UEs 102 can also comprise IOT devices that communicate wirelessly.

In various embodiments, system 100 comprises communication service provider network(s) 106 serviced by one or more wireless communication network providers. Communication service provider network(s) 106 can comprise a “core network”. In example embodiments, UEs 102 can be communicatively coupled to the communication service provider network(s) 106 via network node 104. The network node 104 (e.g., network node device) can communicate with UEs 102, thus providing connectivity between the UEs 102 and the wider cellular network. The UEs 102 can send transmission type recommendation data to the network node 104. The transmission type recommendation data can comprise a recommendation to transmit data via a closed loop multiple input multiple output (MIMO) mode and/or a rank-1 precoder mode.

A network node 104 can have a cabinet and other protected enclosures, computing devices, an antenna mast, and multiple antennas for performing various transmission operations (e.g., MIMO operations) and for directing/steering signal beams. Network node 104 can comprise one or more base station devices which implement features of the network node 104. Network nodes can serve several cells, also called sectors or service areas, such as service area 110, depending on the configuration and type of antenna. In example embodiments, UEs 102 can send and/or receive communication data via a wireless link to the network node 104. The dashed arrow lines from the network node 104 to the UEs 102 represent downlink (DL) communications and the solid arrow lines from the UEs 102 to the network node 104 represents an uplink (UL) communications.

Communication service provider networks 106 can facilitate providing wireless communication services to UEs 102 via the network node 104 and/or various additional network devices (not shown) included in the one or more communication service provider networks 106. The one or more communication service provider networks 106 can comprise various types of disparate networks, including but not limited to: cellular networks, femto networks, picocell networks, microcell networks, internet protocol (IP) networks Wi-Fi service networks, broadband service network, enterprise networks, cloud based networks, millimeter wave networks and the like. For example, in at least one implementation, system 100 can be or comprise a large scale wireless communication network that spans various geographic areas. According to this implementation, the one or more communication service provider networks 106 can be or comprise the wireless communication network and/or various additional devices and components of the wireless communication network (e.g., additional network devices and cell, additional UEs, network server devices, etc.).

The network node 104 can be connected to the one or more communication service provider networks 106 via one or more backhaul links 108. For example, the one or more backhaul links 108 can comprise wired link components, such as a T1/E1 phone line, a digital subscriber line (DSL) (e.g., either synchronous or asynchronous), an asymmetric DSL (ADSL), an optical fiber backbone, a coaxial cable, and the like. The one or more backhaul links 108 can also comprise wireless link components, such as but not limited to, line-of-sight (LOS) or non-LOS links which can comprise terrestrial air-interfaces or deep space links (e.g., satellite communication links for navigation). Backhaul links 108 can be implemented via a “transport network” in some embodiments. In another embodiment, network node 104 can be part of an integrated access and backhaul network. This may allow easier deployment of a dense network of self-backhauled 5G cells in a more integrated manner by building upon many of the control and data channels/procedures defined for providing access to UEs.

Wireless communication system 100 can employ various cellular systems, technologies, and modulation modes to facilitate wireless radio communications between devices (e.g., the UE 102 and the network node 104). While example embodiments might be described for 5G new radio (NR) systems, the embodiments can be applicable to any radio access technology (RAT) or multi-RAT system where the UE operates using multiple carriers e.g. LTE FDD/TDD, GSM/GERAN, CDMA2000 etc.

For example, system 100 can operate in accordance with any 5G, next generation communication technology, or existing communication technologies, various examples of which are listed supra. In this regard, various features and functionalities of system 100 are applicable where the devices (e.g., the UEs 102 and the network device 104) of system 100 are configured to communicate wireless signals using one or more multi carrier modulation schemes, wherein data symbols can be transmitted simultaneously over multiple frequency subcarriers (e.g., OFDM, CP-OFDM, DFT-spread OFMD, UFMC, FMBC, etc.). The embodiments are applicable to single carrier as well as to multicarrier (MC) or carrier aggregation (CA) operation of the UE. The term carrier aggregation (CA) is also called (e.g. interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

In various embodiments, system 100 can be configured to provide and employ 5G or subsequent generation wireless networking features and functionalities. 5G wireless communication networks are expected to fulfill the demand of exponentially increasing data traffic and to allow people and machines to enjoy gigabit data rates with virtually zero (e.g., single digit millisecond) latency. Compared to 4G, 5G supports more diverse traffic scenarios. For example, in addition to the various types of data communication between conventional UEs (e.g., phones, smartphones, tablets, PCs, televisions, internet enabled televisions, AR/VR head mounted displays (HMDs), etc.) supported by 4G networks, 5G networks can be employed to support data communication between smart cars in association with driverless car environments, as well as machine type communications (MTCs). Considering the drastic different communication needs of these different traffic scenarios, the ability to dynamically configure waveform parameters based on traffic scenarios while retaining the benefits of multi carrier modulation schemes (e.g., OFDM and related schemes) can provide a significant contribution to the high speed/capacity and low latency demands of 5G networks. With waveforms that split the bandwidth into several sub-bands, different types of services can be accommodated in different sub-bands with the most suitable waveform and numerology, leading to an improved spectrum utilization for 5G networks.

To meet the demand for data centric applications, features of proposed 5G networks can comprise: increased peak bit rate (e.g., 20 Gbps), larger data volume per unit area (e.g., high system spectral efficiency—for example about 3.5 times that of spectral efficiency of long term evolution (LTE) systems), high capacity that allows more device connectivity both concurrently and instantaneously, lower battery/power consumption (which reduces energy and consumption costs), better connectivity regardless of the geographic region in which a user is located, a larger numbers of devices, lower infrastructural development costs, and higher reliability of the communications. Thus, 5G networks can allow for: data rates of several tens of megabits per second should be supported for tens of thousands of users, 1 gigabit per second to be offered simultaneously to tens of workers on the same office floor, for example; several hundreds of thousands of simultaneous connections to be supported for massive sensor deployments; improved coverage, enhanced signaling efficiency; reduced latency compared to LTE.

The 5G access network can utilize higher frequencies (e.g., >6 GHz) to aid in increasing capacity. Currently, much of the millimeter wave (mmWave) spectrum, the band of spectrum between 30 GHz and 300 GHz is underutilized. The millimeter waves have shorter wavelengths that range from 10 millimeters to 1 millimeter, and these mmWave signals experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the 3GPP and has been in use (including with LTE), is a multi-antenna technique that can improve the spectral efficiency of transmissions, thereby significantly boosting the overall data carrying capacity of wireless systems. The use of MIMO techniques can improve mmWave communications and has been widely recognized as a potentially important component for access networks operating in higher frequencies. MIMO can be used for achieving diversity gain, spatial multiplexing gain and beamforming gain. For these reasons, MIMO systems are an important part of the 3rd and 4th generation wireless systems and are in use in 5G systems.

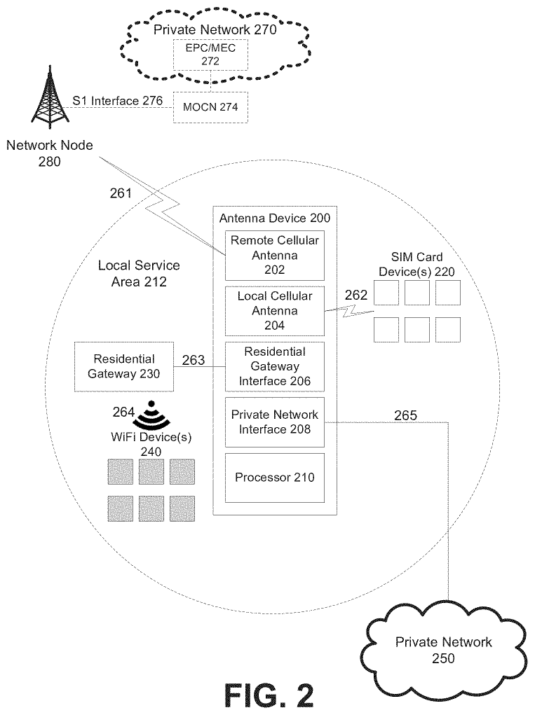

FIG. 2 illustrates an example outdoor antenna device, in accordance with various aspects and embodiments of the subject disclosure. The example antenna device 200 can be configured as an outdoor antenna device. The antenna device 200 comprises a remote cellular antenna 202, a local cellular antenna 204, a residential gateway interface 206, a private network interface 208, and a processor 210.

In an embodiment, the antenna device 200 can comprise an outdoor type antenna device housing, and the remote cellular antenna 202, local cellular antenna 204, residential gateway interface 206, private network interface 208, and processor 210 can be disposed within or otherwise integrated with the housing. The antennas 202 and 204 can comprise any appropriate antenna types, e.g., single element antennas or array antennas. In some embodiments, the remote cellular antenna 202 can comprise a fixed wireless type directional antenna adapted for fixed wireless communications with a remote cellular communication network node 280. The various illustrated antenna elements can be electronically coupled within the antenna device 200, e.g., the remote cellular antenna 202, local cellular antenna 204, residential gateway interface 206, and private network interface 208 can each be coupled with the processor 210, and the processor 210 can be configured to relay communications between the remote cellular antenna 202, local cellular antenna 204, residential gateway interface 206, and private network interface 208 as described herein.

The remote cellular antenna 202 can be configured to wirelessly transmit and receive communications 261 to and from network node 280, wherein the network node 280 is an example of a network node 104 introduced in FIG. 1. In order to wirelessly communicate with network node 280, the antenna device 200 can be situated within a service area of the network node 280. An example service area 110 is illustrated in FIG. 1.

The local cellular antenna 204 can be configured to wirelessly transmit and receive communications 262 to and from subscriber identity module (SIM) card device(s) 220, wherein the SIM card device(s) 220 are examples of UEs 102₁ and 102₂ introduced in FIG. 1. In order to wirelessly communicate with local cellular antenna 204, the SIM card device(s) 220 can be situated within a local service area 212 of the local cellular antenna 204.

The residential gateway interface 206 can be configured to transmit and receive communications 263 to and from residential gateway 230. A connection between the residential gateway interface 206 and the residential gateway 230 can comprise a wired connection, e.g., an Ethernet or other wired connection, and so the residential gateway interface 206 can comprise, e.g., an Ethernet interface. In order to communicate with residential gateway interface 206, the residential gateway 230 can be coupled with the wired connection to the residential gateway interface 206.

The residential gateway 230 can be configured to wirelessly transmit and receive communications 264 to and from Wi-Fi device(s) 240. In order to wirelessly communicate with residential gateway 230, the Wi-Fi device(s) 240 can be situated within a Wi-Fi range of the residential gateway 230.

The private network interface 208 can be configured to transmit and receive communications 265 to and from private network 250. A connection between the private network interface 208 and the private network 250 can comprise a wired connection, e.g., an Ethernet or other wired connection, and so the private network interface 208 can comprise, e.g., an Ethernet interface.

The private network 270 illustrates an example private network configuration which can be rendered unnecessary by the private network 250. S1 interface 276, multi operator core network (MOCN) 274, and evolved packet core (EPC)/multi-access edge computing (MEC) 272 illustrate example elements that can be rendered unnecessary by the private network 250.

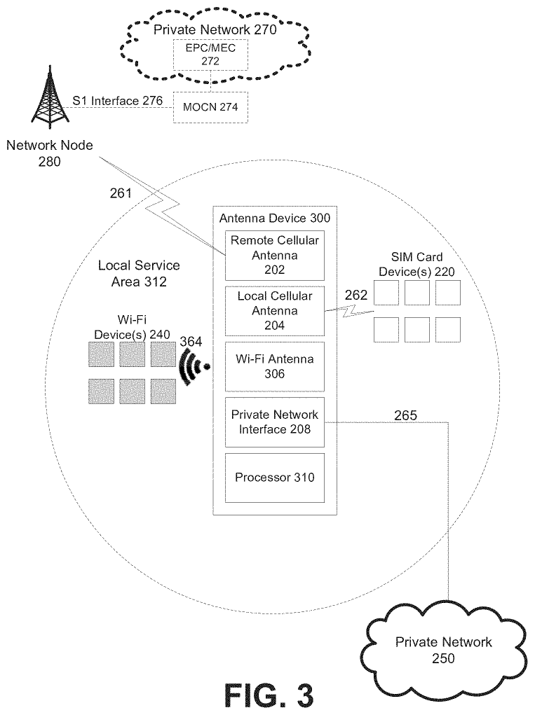

The architecture of a 4G/5G private network such as private network 270 requires an S1 interface 276 comprising user plane external interface (S1-U) connectivity between a wireless carrier service provider and the private network's (MOCN) 274. With antenna devices such as outdoor antenna 200 or indoor antenna 300 (see FIG. 3), wireless carrier service provider signal 261 can be broadcast in outdoor or indoor spaces, and private network 250 can be used to manage SIM card device(s) 220, e.g., Internet of Things (IoT) devices. The illustrated implementation does not require an S1 interface 276 or an MOCN 274 for private network 250. However, in some embodiments, an S1 interface 276, an MOCN 274, and/or an EPC/MEC 272 can optionally be used in connection with private network 250, in addition to a direct local connection between private network 250 and antenna device 200, as illustrated in FIG. 2.

The processor 210 can comprise a processing unit including a processor and a memory that stores executable instructions that, when executed by the processor, facilitate performance of operations. Example operations of the processor 210 include relaying a first communication 263 (e.g., an instance of communications 263) received via the residential gateway interface 206 to the remote cellular antenna 202, and relaying a second communication 261 (e.g., an instance of communications 261) received via the remote cellular antenna 202 to the residential gateway interface 206. For example, communications can be relayed between the Wi-Fi device(s) 240 and the network node 280.

Further example operations of the processor 210 include relaying a third communication 262 (e.g., an instance of communications 262) received via the local cellular communication antenna 204 to the remote cellular antenna 202, and relaying a fourth communication 261 (e.g., an instance of communications 261) received via the remote cellular antenna 202 to the local cellular communication antenna 204. For example, communications can be relayed between the SIM card device(s) 220 and the network node 280.

The third communication 262 can comprise a communication from a particular device of SIM card device(s) 220, and the processor 210 can be configured to use SIM information associated with a SIM within a particular device to identify a source of the third communication 262. The fourth communication 261 can comprise a communication to the particular device comprising the SIM, and the processor 210 can be configured to use the SIM information to identify the destination of the fourth communication 261.

SIM card device(s) 220 can include any of a variety of devices, as can be appreciated. Traditionally, SIM card device(s) 220 include cellular telephones, however increasingly, SIM card device(s) 220 can be IoT type devices. IoT type devices include a large category of devices, including for example appliances such as ovens and refrigerators, as well as sprinklers, thermostats, manufacturing and farming equipment. IoT type devices can have mechanical functions to control a physical property, such as movement of a conveyor belt or temperature of a room. IoT type devices can often, although need not necessarily have fixed locations. SIM card device(s) 220 no longer necessarily include physical SIM cards, instead, a SIM can be implemented as data stored within a device.

The processor 210 can furthermore be configured to relay at least one of the first communication 263, the second communication 261, the third communication 262, or the fourth communication 261 to the private network interface 208. Or, instead of relaying the full content of communications, the processor 210 can be configured to relay data 265 associated with at least one of the first communication 263, the second communication 261, the third communication 262, or the fourth communication 261 to the private network interface 208, in order to send such data 265 to a device within private network 250 that is communicatively coupled with the antenna device 200.

Furthermore, the processor 210 can be configured to relay device management information, as another instance of data 265, from a device of the private network 250 to a device of Wi-Fi device(s) 240 or SIM card device(s) 220. The device to which management information is relayed can be, e.g., a device that is associated with at least one of the first communication 263, the second communication 261, the third communication 262, or the fourth communication 261.

FIG. 3 illustrates an example indoor antenna device, in accordance with various aspects and embodiments of the subject disclosure. The example antenna device 300 can be configured as an indoor antenna device. The antenna device 300 can include some elements identical to those introduced in FIG. 2, and like elements are given like identifiers. The antenna device 300 comprises a remote cellular antenna 202, a local cellular antenna 204, a Wi-Fi antenna 306, a private network interface 208, and a processor 310.

In an embodiment, the antenna device 300 can comprise an indoor type antenna device housing, and the remote cellular antenna 202, local cellular antenna 204, Wi-Fi antenna 306, private network interface 208, and processor 310 can be disposed within or otherwise integrated with the housing. The various illustrated antenna elements can be electronically coupled within the antenna device 300, e.g., the remote cellular antenna 202, local cellular antenna 204, Wi-Fi antenna 306, and private network interface 208 can each be coupled with the processor 310, and the processor 310 can be configured to relay communications between the remote cellular antenna 202, local cellular antenna 204, Wi-Fi antenna 306, and private network interface 208 as described herein.

The Wi-Fi antenna 306 can be configured to wirelessly transmit and receive communications 364 to and from Wi-Fi device(s) 240. In order to wirelessly communicate with Wi-Fi antenna 306, the Wi-Fi device(s) 240 can be situated within a Wi-Fi range of the Wi-Fi antenna 306.

The processor 310 can comprise a processing unit including a processor and a memory that stores executable instructions that, when executed by the processor, facilitate performance of operations. Example operations of the processor 310 can include relaying a first communication 364 (e.g., an instance of communications 364) received via the Wi-Fi antenna 306 to the remote cellular antenna 202, and relaying a second communication 261 (e.g., an instance of communications 261) received via the remote cellular antenna 202 to the Wi-Fi antenna 306. For example, communications can be relayed between the Wi-Fi device(s) 240 and the network node 280.

Further example operations of the processor 310 include relaying a third communication 262 (e.g., an instance of communications 262) received via the local cellular communication antenna 204 to the remote cellular antenna 202, and relaying a fourth communication 261 (e.g., an instance of communications 261) received via the remote cellular antenna 202 to the local cellular communication antenna 204, as described in connection with FIG. 2. The processor 310 can furthermore be configured to relay the communications, data 265 associated with the communications, and device management information to and from the private network interface 208, as described herein.

Antenna devices 200 or 300 include local cellular antennas 204 to broadcast cellular signals, e.g., 4G or 5G signals, outdoors or indoors to SIM card device(s) 220. Users of such antenna devices 200 or 300 can manage a private network 250 for personal and business purposes. Private network 250 can be locally connected to antenna devices 200 or 300 and private network 250 can be adapted to manage cellular communication devices such as SIM card device(s) 220. Processors 210, 310 can be configured to collect data from SIM card device(s) 220, and collected data can be stored on private network 250 for data management and analysis purposes as well as managing specific features offered per SIM card device(s) 220 capabilities.

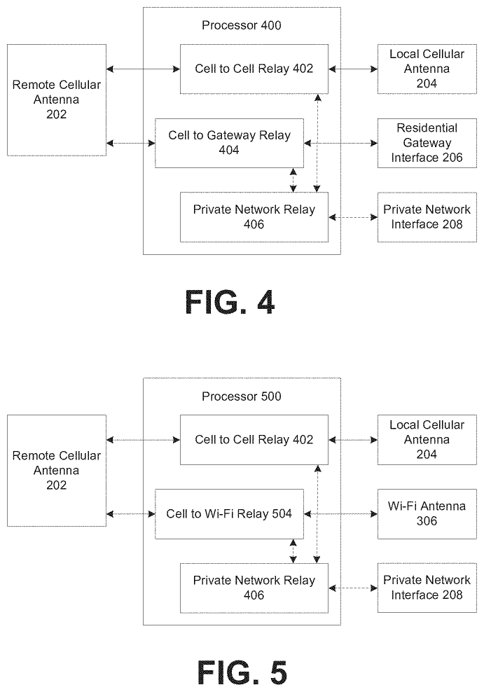

FIG. 4 illustrates an example processor for an outdoor antenna device, in accordance with various aspects and embodiments of the subject disclosure. The example processor 400 can serve as a processor 210 in an outdoor antenna device 200 such as illustrated in FIG. 2. The processor 400 can interact with components of the antenna device 200, including the remote cellular antenna 202, the local cellular antenna 204, the residential gateway interface 206, and the private network interface 208. The example processor 400 comprises a cell to cell relay 402, a cell to gateway relay 404, and a private network relay 406.

The cell to cell relay 402 can be configured to relay communications between the remote cellular antenna 202 and the local cellular antenna 204. For example, cell to cell relay 402 can relay third and fourth communications described in connection with FIG. 2. Furthermore, cell to cell relay 402 can be configured to relay third and fourth communications, or data associated with third and fourth communications, to the private network relay 406.

The cell to gateway relay 404 can be configured to relay communications between the remote cellular antenna 202 and the residential gateway interface 206. For example, cell to gateway relay 404 can relay first and second communications described in connection with FIG. 2. Furthermore, cell to gateway relay 404 can be configured to relay first and second communications, or data associated with first and second communications, to the private network relay 406.

The private network relay 406 can be configured to relay communications received from cell to cell relay 402 or cell to gateway relay 404 to the private network interface 208. Furthermore, the private network relay 406 can be configured to relay management information communications from the private network interface 208 to the cell to cell relay 402 or the cell to gateway relay 404. The private network relay 406 can identify a target device for a management information communication, and determine whether the target device is a Wi-Fi device 240 or a SIM card device 220, and select the cell to cell relay 402 or the cell to gateway relay 404 based on whether the target device is a Wi-Fi device 240 or a SIM card device 220, and send the management information communication to the target device via the selected relay.

FIG. 5 illustrates an example processor for an indoor antenna device, in accordance with various aspects and embodiments of the subject disclosure. The example processor 500 can serve as a processor 310 in an indoor antenna device 300 such as illustrated in FIG. 3. The processor 500 can include some elements identical to those introduced in FIG. 4, and like elements are given like identifiers. The processor 500 can interact with components of the antenna device 300, including the remote cellular antenna 202, the local cellular antenna 204, the Wi-Fi antenna 306, and the private network interface 208. The example processor 500 comprises a cell to cell relay 402, a cell to Wi-Fi relay 504, and a private network relay 406.

The cell to Wi-Fi relay 504 can be configured to relay communications between the remote cellular antenna 202 and the Wi-Fi antenna 306. For example, cell to Wi-Fi relay 504 can relay first and second communications described in connection with FIG. 3. Furthermore, cell to Wi-Fi relay 504 can be configured to relay first and second communications, or data associated with first and second communications, to the private network relay 406.

The private network relay 406 can be configured to relay communications received from cell to cell relay 402 or cell to Wi-Fi relay 504 to the private network interface 208. Furthermore, the private network relay 406 can be configured to relay management information communications from the private network interface 208 to the cell to cell relay 402 or the cell to Wi-Fi relay 504. The private network relay 406 can identify a target device for a management information communication, and determine whether the target device is a Wi-Fi device 240 or a SIM card device 220, and select the cell to cell relay 402 or the cell to Wi-Fi relay 504 based on whether the target device is a Wi-Fi device 240 or a SIM card device 220, and send the management information communication to the target device via the selected relay.

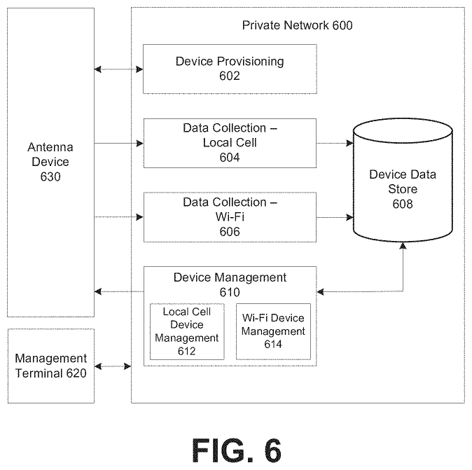

FIG. 6 illustrates an example private network, in accordance with various aspects and embodiments of the subject disclosure. The example private network 600 is an example configuration of a private network 250. The example private network 600 includes device provisioning 602, data collection—local cell 604, data collection—Wi-Fi 606, device data store 608, and device management 610. Device management 610 includes local cell device management 612 and Wi-Fi device management 614.

The private network 600 can be implemented by one or more networked computing devices and can implement a cluster or a cloud in some embodiments. The private network 600 can be coupled with a management terminal 620 as well as an antenna device 630 via local network area network (LAN) type connections. The management terminal 620 can be configured to access the private network 600 to configure the private network 600, e.g., to view reports comprising data from device data store 608 and to configure device management information. The private network 600 can be coupled with an antenna device 630, e.g., an antenna device such as 200 or 300. The private network 600 can be configured to send and receive data to network devices, e.g., Wi-Fi device(s) 240 and/or SIM card device(s) 220, via the antenna device 630.

Device provisioning 602 can be configured to provision devices, e.g., SIM card device(s) 220, to interact with the private network 600. For example, management information such as device configuration settings can be provided to SIM card device(s) 220 so that SIM card device(s) 220 correctly send and receive data to and from private network 600 via antenna device 630. Data collection—local cell 604 can be configured to receive communications or associated data, sent via a local cellular antenna of antenna device 630. Data collection—local cell 604 can furthermore be configured to store received information in device data store 608. An example cellular communication received and stored by data collection—local cell 604 can comprise a status update of multiple status updates from a SIM card device such as a user equipment, wherein the user equipment is associated with a stationary device comprising a sensor, which is one potential configuration for an example IoT device.

Data collection—Wi-Fi 606 can be configured to receive communications or associated data, sent via a Wi-Fi antenna or a residential gateway interface of antenna device 630. Data collection—Wi-Fi 606 can furthermore be configured to store received information in device data store 608.

Local cell device management 612 can be configured to send, via a local area network communication link between the private network 600 and the antenna device 630, device management information to SIM card device(s) 220. Wi-Fi device management 614 can be configured to send, via the local area network communication link between the private network 600 and the antenna device 630, device management information to Wi-Fi device(s) 240. Example management information can comprise frequency of status updates, scope of status updates, scope of status updates, energy use instructions such as uptime and downtime or sleep settings, information pertaining to device cooperation and interaction with other devices, and/or updated network communication settings.

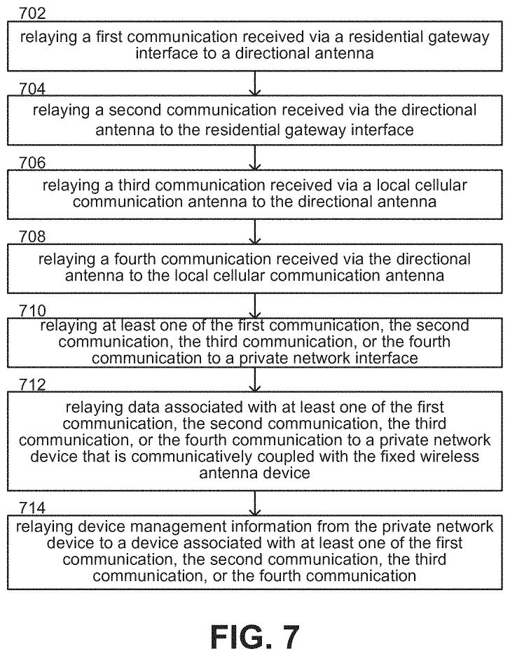

FIG. 7 is a flow diagram representing example operations of an outdoor antenna device, in accordance with various aspects and embodiments of the subject disclosure. The illustrated blocks can represent actions performed in a method, functional components of a computing device, or instructions implemented in a machine-readable storage medium executable by a processor. While the operations are illustrated in an example sequence, the operations can be eliminated, combined, or re-ordered in some embodiments.

The operations illustrated in FIG. 7 can be performed, for example, by an antenna device 200 such as illustrated in FIG. 2. Example operation 702 comprises relaying a first communication (e.g., an instance of communications 263) received via the residential gateway interface 206 to the remote cellular antenna 202. The remote cellular antenna can be implemented by a directional antenna as described herein. Example operation 704 comprises relaying a second communication (e.g., an instance of communications 261) received via the remote cellular antenna 202 to the residential gateway interface 206.

Example operation 706 comprises relaying a third communication (e.g., an instance of communications 262) received via the local cellular communication antenna 204 to the remote cellular antenna 202. The third communication 262 can comprise a communication from a device comprising a SIM, such as one of SIM device(s) 220, and SIM information associated with the device's SIM can be used to identify a source of the third communication 262. The device comprising the SIM can be, e.g., an IoT type device associated with a fixed location, or designed to carry out a series of measurements or physical actions.

Example operation 708 comprises relaying a fourth communication (e.g., an instance of communications 261) received via the remote cellular antenna 202 to the local cellular communication antenna 204. The fourth communication can comprise a communication to the device comprising the SIM, identified as the source of the third communication 262 at operation 706. SIM information can be used to identify a destination of the fourth communication 261, i.e., the source device.

Example operation 710 comprises relaying at least one of the first communication 264, the second communication 261, the third communication 262, or the fourth communication 261 to the private network interface 208. Example operation 712 can be performed in addition to operation 710, or as an alternative to operation 710 in some embodiments. Example operation 712 comprises relaying data 265 associated with at least one of the first communication 264, the second communication 261, the third communication 262, or the fourth communication 261 to a private network device (in private network 250) that is communicatively coupled with the fixed wireless antenna device 200.

Example operation 714 comprises relaying device management information from the private network device (in private network 250) to a device associated with at least one of the first communication 264, the second communication 261, the third communication 262, or the fourth communication 261.

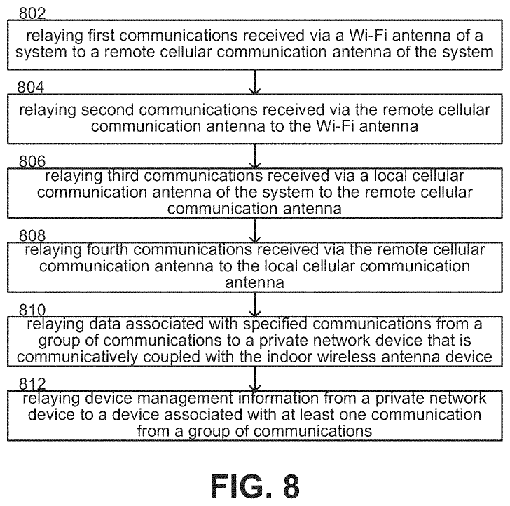

FIG. 8 is a flow diagram representing example operations of an indoor antenna device, in accordance with various aspects and embodiments of the subject disclosure. The illustrated blocks can represent actions performed in a method, functional components of a computing device, or instructions implemented in a machine-readable storage medium executable by a processor. While the operations are illustrated in an example sequence, the operations can be eliminated, combined, or re-ordered in some embodiments.

The operations illustrated in FIG. 8 can be performed, for example, by a system comprising an antenna device 300 such as illustrated in FIG. 3. Example operation 802 comprises relaying first communications (e.g., an instance of communications 364) received via a Wi-Fi antenna 306 of the system to a remote cellular communication antenna 202 of the system. Example operation 804 comprises relaying second communications (e.g., an instance of communications 261) received via the remote cellular communication antenna 202 to the Wi-Fi antenna 306.

Example operation 806 comprises relaying third communications (e.g., an instance of communications 262) received via a local cellular communication antenna 204 of the system to the remote cellular communication antenna 202. The third communications 262 can comprise a communication from a device comprising a SIM, such as one of SIM device(s) 220, and SIM information associated with the device's SIM can be used to identify a source of the third communication 262. The device comprising the SIM can be, e.g., an IoT type device associated with a fixed location, or designed to carry out a series of measurements or physical actions.

Example operation 808 comprises relaying fourth communications (e.g., an instance of communications 261) received via the remote cellular communication antenna 202 to the local cellular communication antenna 204. The fourth communication can comprise a communication to the device comprising the SIM, identified as the source of the third communication 262 at operation 706. SIM information can be used to identify a destination of the fourth communication 261, i.e., the source device.

Example operation 810 comprises relaying data associated with specified communications from a group of communications to a private network device (of private network 250) that is communicatively coupled with the indoor wireless antenna device 300. The group of communications can comprise, e.g., the first communications 364, the second communications 261, the third communications 262, and the fourth communications 261.

Example operation 812 comprises relaying device management information from a private network device (of private network 250) to a device, e.g., one of Wi-Fi device(s) 240 or SIM card device(s) 220 associated with at least one communication from a group of communications. The group of communications can comprise, e.g., the first communications 364, the second communications 261, the third communications 262, and the fourth communications 261.

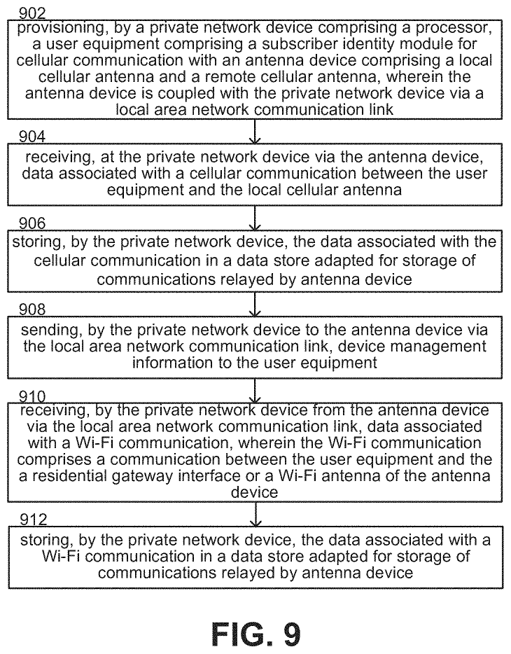

FIG. 9 is a flow diagram representing example operations of a private network, in accordance with various aspects and embodiments of the subject disclosure. The illustrated blocks can represent actions performed in a method, functional components of a computing device, or instructions implemented in a machine-readable storage medium executable by a processor. While the operations are illustrated in an example sequence, the operations can be eliminated, combined, or re-ordered in some embodiments.

The operations illustrated in FIG. 9 can be performed, for example, by one or more devices that implement the private network 600 illustrated in FIG. 6. Example operation 902 comprises provisioning, by a private network device comprising a processor, a user equipment, e.g., a device of SIM device(s) 220 which comprises a SIM for cellular communication with an antenna device 630 comprising a local cellular antenna and a remote cellular antenna, wherein the antenna device 630 is coupled with the private network device via a local area network communication link.

Example operation 904 comprises receiving, at the private network device via the antenna device 630, data associated with a cellular communication between the user equipment and the local cellular antenna. For example, data collection—local cell 604 can receive the cellular communication via the local cellular antenna device within antenna device 630. The cellular communication can comprise, e.g., a status update of multiple status updates from the user equipment. The user equipment can be, e.g., associated with a stationary device comprising a sensor.

Example operation 906 comprises storing, by the private network device, e.g., by data collection—local cell 604, the data associated with the cellular communication in a data store 608 adapted for storage of communications relayed by antenna device 630.

Example operation 908 comprises sending, by the private network device, e.g., by local cell device management 612, to the antenna device 630, via the local area network communication link, device management information to the user equipment. According to the techniques described herein, Wi-Fi device management 614 can separately manage Wi-Fi device(s) 240, so that Wi-Fi device(s) 240 can be managed separately from SIM card device(s) 220.

Example operation 910 comprises receiving, by the private network device, e.g., by data collection—Wi-Fi 606, from the antenna device 630 via the local area network communication link, data associated with a Wi-Fi communication, wherein the Wi-Fi communication comprises a communication between the user equipment and a residential gateway interface or a Wi-Fi antenna of the antenna device 630. For example, data collection—Wi-Fi 606 can receive information via a Wi-Fi antenna or residential gateway within antenna device 630. Example operation 912 comprises storing, by the private network device, e.g., by data collection—Wi-Fi 606, the data associated with a Wi-Fi communication in a data store 608 adapted for storage of communications relayed by the antenna device 630.

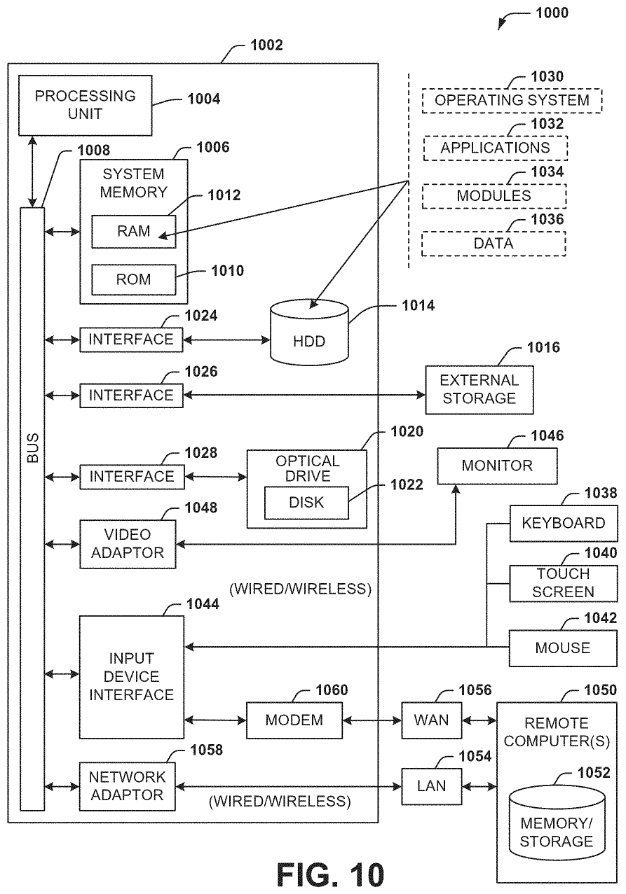

FIG. 10 is a block diagram of an example computer that can be operable to execute processes and methods in accordance with various aspects and embodiments of the subject disclosure. The example computer can be adapted to implement, for example, any of the various network equipment described herein.

FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), smart card, flash memory (e.g., card, stick, key drive) or other memory technology, compact disk (CD), compact disk read only memory (CD-ROM), digital versatile disk (DVD), Blu-ray™ disc (BD) or other optical disk storage, floppy disk storage, hard disk storage, magnetic cassettes, magnetic strip(s), magnetic tape, magnetic disk storage or other magnetic storage devices, solid state drives or other solid state storage devices, a virtual device that emulates a storage device (e.g., any storage device listed herein), or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments of the aspects described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA), one or more external storage devices 1016 (e.g., a magnetic floppy disk drive (FDD) 1016, a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enabled with a security module, such as a trusted processing module (TPM). For instance with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art can recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A fixed wireless antenna device, comprising:
a directional antenna adapted for fixed wireless communications with a remote cellular communication network node;
a residential gateway interface;
a local cellular communication antenna;
a processor; and
a memory that stores executable instructions that, when executed by the processor, facilitate performance of operations, comprising:
relaying a first communication received via the residential gateway interface to the directional antenna;
relaying a second communication received via the directional antenna to the residential gateway interface;
relaying a third communication received via the local cellular communication antenna to the directional antenna; and
relaying a fourth communication received via the directional antenna to the local cellular communication antenna.

2. The fixed wireless antenna device of claim 1, further comprising a private network interface, and wherein the operations further comprise relaying at least one of the first communication, the second communication, the third communication, or the fourth communication to the private network interface.

3. The fixed wireless antenna device of claim 1, wherein the operations further comprise relaying data associated with at least one of the first communication, the second communication, the third communication, or the fourth communication to a private network device that is communicatively coupled with the fixed wireless antenna device.

4. The fixed wireless antenna device of claim 3, wherein the operations further comprise relaying device management information from the private network device to a device associated with at least one of the first communication, the second communication, the third communication, or the fourth communication.

5. The fixed wireless antenna device of claim 1, wherein the third communication comprises a communication from a device comprising a subscriber identity module, and wherein subscriber identity module information associated with the subscriber identity module is used to identify a source of the third communication.

6. The fixed wireless antenna device of claim 5, wherein the device comprising the subscriber identity module is associated with a fixed location.

7. The fixed wireless antenna device of claim 5, wherein the fourth communication comprises a communication to the device comprising the subscriber identity module, and wherein the subscriber identity module information is used to identify a destination of the fourth communication.

8. A system, comprising:
a processor; and
a memory that stores executable instructions that, when executed by the processor, facilitate performance of operations, comprising:
relaying first communications received via a Wi-Fi antenna of the system to a remote cellular communication antenna of the system;
relaying second communications received via the remote cellular communication antenna to the Wi-Fi antenna;
relaying third communications received via a local cellular communication antenna of the system to the remote cellular communication antenna; and
relaying fourth communications received via the remote cellular communication antenna to the local cellular communication antenna.

9. The system of claim 8, wherein the system is an indoor wireless antenna device, wherein the operations further comprise relaying data associated with specified communications from a group of communications to a private network device that is communicatively coupled with the indoor wireless antenna device, and wherein the group of communications comprises the first communications, the second communications, the third communications, and the fourth communications.

10. The system of claim 8, wherein the operations further comprise relaying device management information from a private network device to a device associated with at least one communication from a group of communications, and wherein the group of communications comprises the first communications, the second communications, the third communications, and the fourth communications.

11. The system of claim 8, wherein the third communications comprise a first communication from a device comprising a subscriber identity module, and wherein subscriber identity module information associated with the subscriber identity module is used to identify a source of the first communication.

12. The system of claim 11, wherein the device comprising the subscriber identity module is part of a device comprising a sensor.

13. The system of claim 11, wherein the fourth communications comprise a second communication to the device comprising the subscriber identity module, and wherein the subscriber identity module information is used to identify a destination of the second communication.

14. A method, comprising:
provisioning, by a private network device comprising a processor, a user equipment comprising a subscriber identity module for cellular communication with an antenna device comprising a local cellular antenna and a remote cellular antenna, wherein the antenna device is coupled with the private network device via a local area network communication link;
receiving, by the private network device via the antenna device, data associated with a cellular communication between the user equipment and the local cellular antenna; and
storing, by the private network device, the data associated with the cellular communication in a data store adapted for storage of communications relayed by antenna device.

15. The method of claim 14, further comprising sending, by the private network device to the antenna device via the local area network communication link, device management information to the user equipment.

16. The method of claim 14, further comprising receiving, by the private network device from the antenna device via the local area network communication link, data associated with a Wi-Fi communication, wherein the Wi-Fi communication comprises a communication between the user equipment and a residential gateway interface or a Wi-Fi antenna of the antenna device.

17. The method of claim 14, further comprising storing, by the private network device, the data associated with a Wi-Fi communication in a data store adapted for storage of communications relayed by antenna device.

18. The method of claim 14, wherein the cellular communication comprises a status update of multiple status updates from the user equipment, and wherein the user equipment is associated with a stationary device comprising a sensor.

19. The method of claim 14, wherein the remote cellular antenna comprises a fixed wireless antenna device adapted for outdoor wireless communication.

20. The method of claim 14, wherein the antenna device comprises an indoor wireless antenna device.
